(19) United States
(12) Patent Application Publication
(10) Pub. No.: US 2012/0150633 A1
(43) Pub. Date: Jun. 14, 2012

(54) GENERATING ADVERTISEMENTS DURING INTERACTIVE ADVERTISING SESSIONS

(75) Inventors: Wook Jin Chung, Kirkland, WA (US); Pritesh Patwa, Redmond, WA (US); Martin Miroslavov Markov, Bellevue, WA (US)

(73) Assignee: MICROSOFT CORPORATION, Redmond, WA (US)

(21) Appl. No.: 12/963,286

(22) Filed: Dec. 8, 2010

(51) Int. Cl. G06Q 30/00

(52) U.S. Cl. 705/14.49; 705/14.4

(57) ABSTRACT

A method, computer readable media, and computer system for generating advertisement messages are provided. The computer system includes an advertisement engine and an advanced interactive platform that receive user events. The advanced interactive platform selects response templates associated with user events received from a user. In turn, the advanced interactive platform transmits the response templates to the advertisement engine. The advertisement engine processes the response template and populates the response template with advertising hints to dynamically generate advertisement messages. The advertisement engine may include indicators that solicit user feedback in the advertisement message. The user feedback received by the advanced interactive platform triggers additional user events that are used to generate additional advertisements and to discover interests of the user.

### BACKGROUND

An online advertisement is often selected to be presented to a user based on a prediction that the ad will be relevant to the user. For example, the advertisement might be selected based on a keyword included among content of a webpage requested by the user. The advertisement might also be selected based on prior activities (e.g., browsing history) of the user. Generally, the advertisement is displayed to the user for a specific period of time. In turn, the advertisement may change when the period of time expires.

### SUMMARY

Embodiments of the invention are defined by the claims below, not this summary. A high-level overview of various aspects of the invention are provided here for that reason, to provide an overview of the disclosure, and to introduce a selection of concepts that are further described below in the detailed-description section. This summary is not intended to identify key features or essential features of the claimed subject matter, nor is it intended to be used as an aid in isolation to determine the scope of the claimed subject matter.

A computer system is configured to dynamically generate additional advertisement messages based on user interactions with previous advertisement messages during an advertisement session. The computer system includes a database and an advertising engine. The database is configured to store advertising hints obtained from advertisers. The advertising engine is configured to receive user events and response templates associated with the user events. The advertising engine populates the response templates to generate advertisement messages that are transmitted to the user. In turn, the advertising engine solicits user interaction with the advertisement messages to discover the user's interests that are utilized for additional advertisement messages.

### BRIEF DESCRIPTION OF THE DRAWINGS

Illustrative embodiments of the invention are described in detail below with reference to the attached drawing figures, wherein:

FIG. 1 is a component diagram illustrating an exemplary computing environment suitable for use in accordance with embodiments of the invention;

FIG. 2 is a block diagram illustrating an exemplary advertisement session in accordance with embodiments of the invention; and

FIG. 3 is a logic diagram illustrating an exemplary method of providing interactive advertisement sessions in accordance with embodiments of the invention.

### DETAILED DESCRIPTION

The subject matter of embodiments of the invention is described with specificity herein to meet statutory requirements. But the description itself is not intended to necessarily limit the scope of the claims. Rather, the claimed subject matter might be embodied in other ways to include different steps or combinations of steps similar to the ones described in this document, in conjunction with other present or future technologies. Terms should not be interpreted as implying any particular order among or between various steps herein described unless and except when the order of individual steps is explicitly stated.

Embodiments of the invention provide advertisement sessions that include several advertisement messages that are dynamically generated based on user interactions. The advertisement messages are generated using advertising hints and the user interaction. The user interaction with the advertisement is received by a client device. The user interaction may include gestures, voice patterns, pointer selections, etc. The user interaction is associated with a response template. The user interaction and response template are transmitted to the advertising engine. In one embodiment, the advertising engine obtains the advertising hints from advertisers. The advertising engine generates an advertisement message by populating the response template with the advertising hints. The advertisement message may include various indicators that solicit additional user interaction. The advertising engine engages the user in an advertisement session to discover the interests of the user. The advertisement session includes the advertisement messages that are dynamically generated based on the user interactions. The user interactions with previous advertisement messages during the advertisement session are used by the advertising engine to generate subsequent advisement messages during the advertising session. In some embodiments, the advertising session may include advertising hints from different advertisers.

The response templates may be stored in storage and accessed based on observable criteria including user context, user interactions, client device utilized by user, etc. For instance, several response templates may be available when the user interaction indicates that the user is hungry. The response templates may include fields for advertising hints. After determining that the user is hungry, the advertising engine may select either of the following templates: “Do you want to see the special offer from {RESTAURANT}” or “How about going to {RESTAURANT}.” The advertising engine selects appropriate advertising hints to populate the “RESTAURANT” field. Also, the response templates for a hungry user may take into consideration the applications a user interacts with and the device the user is interacting with. For instance, if the user is playing a gaming device, the response template may include, but is not limited to, “Would you like to check out the cool deals from [RESTAURANT]” or “How about continuing this game on your Windows Phone 7 at [RESTAURANT].” Accordingly, the response templates may be tailored to both the user's context and user interaction.

In certain embodiments, a computer system monitors user interaction with advertisement messages and provides advertisement sessions that solicit user feedback to determine the content of subsequent advertisement messages. Accordingly, the content of the advertisement messages are not statically defined. Rather, the content of the advertisement messages are dynamically generated in accordance with the user feedback. In some embodiments, generation and composition of advertisement messages is performed by the advertising engine instead of the advertisers. The advertisers provide advertising hints to the advertising engine, which utilizes response templates and the advertising hints to dynamically generate the advertisement messages. The user feedback includes user events triggered by user interaction with the computer system or previous advertisement messages displayed on the computer system. In one embodiment, the length of time an advertisement message is displayed on the computer system may depend on the user interactions. Thus, advertisement content, relevance, and ranking may depend on the user feedback instead of keywords or prior browse behavior.

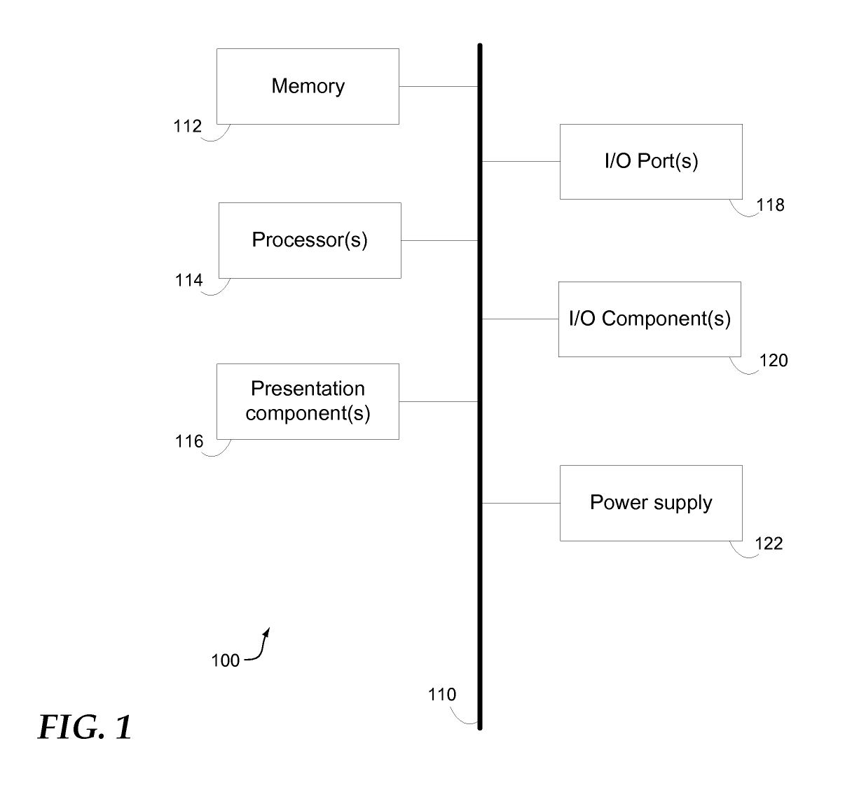

FIG. 1 is a component diagram illustrating an exemplary computing environment 100 suitable for use in accordance with embodiments of the invention. The computer environment 100 includes bus 110, memory 112, processors 114, presentation components 116, input/output ports 118, input/output components 120, and power supply 122. Computing environment 100 is but one example and is not intended to suggest any limitation as to the scope of use or functionality of invention embodiments. Neither should the computing environment 100 be interpreted as having any dependency or requirement relating to any one or combination of components illustrated.

Embodiments of the invention might be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that performs particular tasks or implements particular abstract data types. Embodiments of the invention might be practiced in a variety of system configurations, including handheld devices, consumer electronics, Microsoft Kinect™, general-purpose computers, more specialty computing devices, etc. Embodiments of the invention might also be practiced in distributed computing environments where tasks are performed by remote-processing devices that are linked through a communications network.

Embodiments of the present invention may be embodied as, among other things: a method, system, or set of instructions embodied on one or more computer-readable media. Computer-readable media include both volatile and nonvolatile media, removable and nonremovable media, and contemplates media readable by a database, a switch, and various other network devices. By way of example, and not limitation, computer-readable media comprise media implemented in any method or technology for storing information. Examples of stored information include computer-useable instructions, data structures, program modules, and other data representations. Media examples include, but are not limited to information-delivery media, RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data momentarily, temporarily, or permanently.

With reference to FIG. 1, the computing environment 100 includes the bus 110 that directly or indirectly couples the following devices: memory 112, one or more processors 114, one or more presentation components 116, input/output ports 118, input/output components 120, and a power supply 122. Bus 110 represents what might be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art and reiterate that the diagram of FIG. 1 is merely illustrative of an exemplary computing device that can be used in connection with one or more embodiments of the invention. Distinction is not made between such categories as “workstation,” “server,” “laptop,” “handheld device,” etc., as all are contemplated within the scope of FIG. 1 and “computing environment 100.”

Computing environment 100 typically includes a variety of computer-readable media. By way of example, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing environment 100.

Memory 112 includes computer-readable media in the form of volatile and/or nonvolatile memory. The memory may be removable, nonremovable, or a combination thereof. Exemplary hardware devices include solid-state memory, hard drives, optical-disc drives, etc. Computing environment 100 includes one or more processors 114 that read data from various entities such as memory 112 or I/O components 120.

Presentation component(s) 116 present data indications to a user or other device. Exemplary presentation components 116 include a display device, speaker, printing component, vibrating component, etc.

I/O ports 118 allow the computing device to be logically coupled to other devices including I/O components 120, some of which may be built in. Illustrative I/O components 120 include a microphone, joystick, game pad, satellite dish, cameras, scanner, printer, wireless device, etc.

In certain embodiments, the computing environment 100 includes an advanced interactive platform (AIP) that monitors user interactions and dynamically generates advertisement messages during an advertisement session. The AIP is not a deterministic advertising solution because the advertisement messages are not previously generated by advertisers. Instead, AIP is an opportunistic advertising solution that allows an advertising engine to dynamically generate advertisement messages based on the monitored user interactions. The advertising engine exposes an appropriate interface, e.g., webpage, for advertiser to submit advertising hints that are utilized in various advertisement messages generated by the advertising engine.

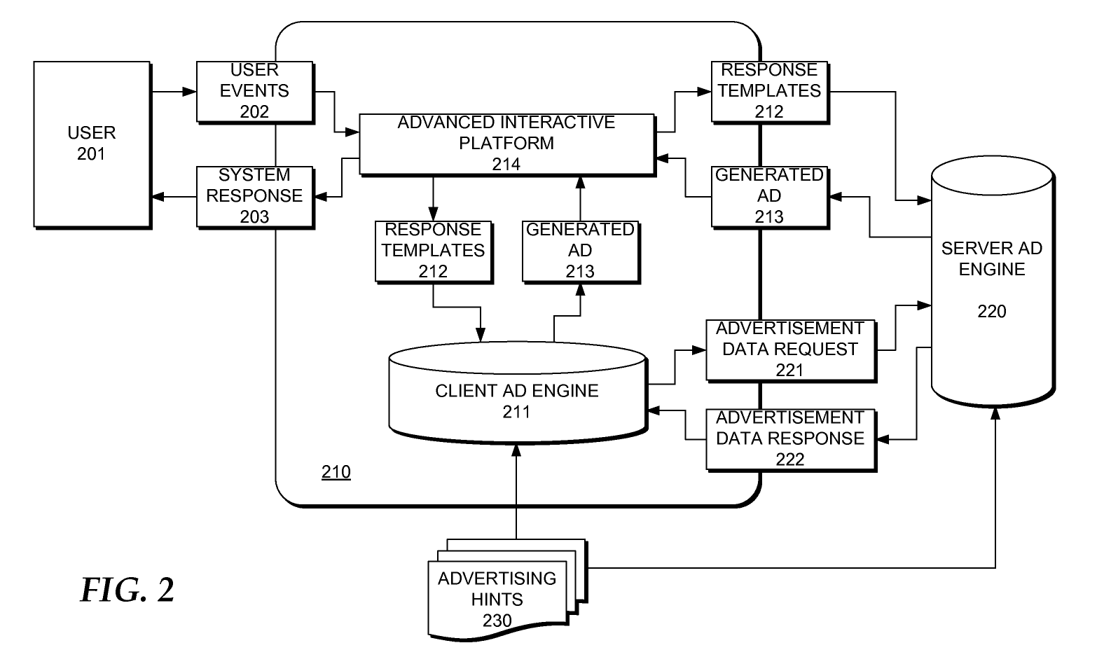

FIG. 2 is a block diagram illustrating an exemplary advertisement session in accordance with embodiments of the invention. A user 201 interacts with a client device 210. In turn, the client device 210 displays advertisement messages during advertisement sessions to the user 201. The advertisement sessions may be provided by a client ad engine 211 on the client device 210 or a server ad engine 220. The advertisement messages are generated utilizing advertising hints 230.

The client device 210 is a computing environment that provides advertising sessions to the user 201. In some embodiments, the client device is Microsoft Kinect™. The client device 210 may include a client ad engine 211 and AIP 214. The client device 210 monitors the user interaction and receives user events 202 from the user 201. The client device 210 also provides a system response 203 that may include the generated advertisement messages 213. In one embodiment, the generated ad 213 is provided by the client ad engine 211. In another embodiment, the generated ad 213 is provided by the server ad engine 220.

The user events 202 are user interactions that cause the client device 210 to initialize an advertisement session. In some embodiments, the user events may include voice patterns, e.g., “I am hungry,” “It's lunch time,” “I am thirsty,” gestures, e.g., pointing at a system response 203 provided by the client device 210, assigned emotional states, e.g., “happy,” “excited,” or “anxious,” and keyboard or pointer strokes, e.g., hovering over or selecting an item displayed on the client device 210. The user events 202 are identified via microphones, cameras, or other input devices available on the client device 210. For instance, the microphones may capture a user interaction, which indicates food is desired. In turn, the client device 210 generates a user event 202 indicating that food is requested.

The system response 203 includes an advertisement message that is based on the user event 202 and the advertising hints 230. The system response 203 is provided by the client device. In some embodiments, the system response 203 solicits the user for feedback and interaction. In turn, subsequent system responses 203 are provided to the user 201 during the advertisement session.

The client ad engine 211 processes the response templates 212 and selects appropriate advertising hints 230 to populate the response templates 212. The client ad engine 211 dynamically provides generated ads 213. The client ad engine 211 includes solicitations for additional user interaction in the generated ads during the advertisement session. The client ad engine 211 utilizes the categories associated with response templates to discover interests of the user. In other embodiments, the client ad engine 211 may provide static advertisements when the client device 210 does not receive user events 202. The client ad engine 211 may submit an advertisement data request 221 to the server ad engine 220 for static advertisements. In turn, the client ad engine 211 receives an advertisement data response 222 from the server ad engine 220 that include one or more static advertisements. The static advertisements are rendered to the user.

The response templates 212 are selected based on user's context and user interaction. Also, a plurality response templates 212 may be selected based on the user interaction or context. The plurality of response templates 212 may have a sequence that moves from broad response templates 212 to specific response templates 212 or specific response templates 212 to broad response templates 212. In other embodiments, the plurality of response templates 212 are sequenced based on the user interaction.

Accordingly, the selection of response templates 212 is flexible because a variety of response templates 212 are provided by the AIP 214. For instance, AIP 214 may provide response templates are static or dynamic. The dynamic response templates 212 may include response template 212 that are generated based on scripts or response templates 212 that are multi-tiered, where prior user interaction with advertisement message generated from the multi-tiered response template 212, influences subsequent levels selected for the multi-tiered response template 212.

In other embodiments, the response templates 212 are selected based on the user event 202. The AIP 214 may categorize the user events 202 and response templates 212. The categories may include restaurants, electronics, real estate, investments, travel, gaming, hobbies, etc. The response templates 212 selected by the AIP 214 may be from a similar category that is associated with user events 202. In certain embodiments, the response templates 212 include fields that are populated with advertising hints 230. The response templates 212 are selected by the AIP 214 and transmitted to the client ad engine 211. Alternatively, the response templates 212 may be transmitted to the server ad engine 220. In one embodiment, the user event 202 and response templates 212 are bundled together and transmitted to either the client ad engine 211 or the server ad engine 220.

The generated ad 213 is received by the AIP 214 from the client ad engine 211 or server ad engine 220. The generated ad is a response template populated with advertising hints 230. The generated ad 213 may include a solicitation for user feedback. The AIP 214 processes the generated ad 213 and sends a system response 203 including the generated ad 213 to the user 201. In turn, the AIP 214 may receive additional user events 202 that are based on the user feedback and interaction with the generated ad 213.

The AIP 214 stores response templates 212 in various categories. The AIP 214 also processes the user events 202 to determine one or more categories that are associated with the user events 202. For instance, the AIP 214 may categorize a user event 202 based on user interactions that indicate the user is interested in shopping for gifts with electronics category, travel category, etc. The AIP formats the generated ad 213. In some embodiments, the formatting includes determining whether to deliver the advertisement as an image, audio, etc. The formatting selected for the generated ad 213 may be based on user preferences or advertising hints 230. In turn, the AIP delivers the system response 203 to the user 201.

In alternative embodiments, the server ad engine 220 processes the response templates 212 and selects appropriate advertising hints 230 to populate the response templates 212. The server ad engine 211 dynamically provides generated ads 213. The server ad engine 211 includes solicitations for additional user interaction in the generated ads during the advertisement session. The server ad engine utilizes the categories associated with response templates to discover interests of the user. In at least one embodiment, the discovered interests are stored in a user profile associated with the user 201.

The advertising hints 230 are provided by advertisers. The advertising hints 230 may include brand data, nearest store locations, special offers, or short messages that promote the advertisers products. The client ad engine 211 and server ad engine 220 utilize the advertising hints 230 to dynamically provide generated ads 213 to the AIP 214. Thus, the generated ad 213 may differ for the users 201 of the client device 210. In some embodiments, the advertising hints 230 may include a media preference that indicates whether the advertiser prefers the generated ad 213 delivered as a video, audio, or images.

For instance, the advertising hints 230 may include {name}, {price}, {category}, {subcategory}, {cuisine}, {calorie}, {image}, {location}, or {hours of operation}. In certain embodiments, the client ad engine 211 or server ad engine 220 may utilize the advertising hints 230 to prioritize advertisers and to populate the response templates 212. During user interaction with generated ads 213, when a user indicates an disinterest in fast food, advertisers having advertising hints 230 {category} or {subcategory}as fast food are not considered when selecting advertising hints for a next generated ad 213. Similarly, when the user's interaction indicates an interest in food at a time outside of the normal operation hours of several advertisers' restaurants, advertisers having advertising hint 230 {hours of operation}at times that do not overlap with current time of the user's interest in food are not considered when selecting advertising hints for a next generated ad 213. Accordingly, advertising hints may be used to influence the advertisers that are available for the next generated ad 213.

The advertisement session may be a period of time that a user is engaged with several system responses 203. During the advertisement session, various system responses 203 are targeted to solicit additional information about the interests of the user. The client device 210 delivers a personalized and interactive experience based on the feedback received during the advertisement session.

In an embodiment of the invention, the user does not use the computer system to explicitly search for a commodity or service online. And the computer system does not receive static advertisement associated with the user explicitly searching for a commodity or service online. Instead a user interacts with a client device having an AIP that dynamically provides relevant advertisements to the user.

A client ad engine or server ad engine may receive a first user event from the AIP. The first user event may include voice, gestures, emotional state, or keyboard strokes that are related to a topic that a user is presently interested in. A first response template associated with the first user event is also received by the ad engine. In turn, a first advertisement message is generated by populating a response template with one or more advertising hints provided by advertisers. The advertising hints may comprise brand, expertise, store location, special offers, and user targeting data. The first advertisement message is delivered to the user. The first advertisement message may be formatted as an audio advertisement, a graphical advertisement, a video advertisement, or an animated graphical advertisement. In turn, user interaction with the first advertisement message is solicited.

Subsequent user events are received based on the user interaction with the first advertisement message. The ad engine also receives subsequent response templates associated with the subsequent user events. The subsequent response templates are selected based on the first response template.

Subsequent advertisement messages are generated by populating the subsequent response templates with the one or more advertising hints. In one embodiment, the subsequent response templates are populated with advertising hints from advertisers that differ from the advertising hints used to populate the first response template. In other embodiments, the subsequent response templates are populated with additional advertising hints from the same advertiser whose advertising hints were used to populate the first response template.

In one embodiment, the advertising session begins when the first user event is received by an advertising engine. The advertising session ends when the users cease to interact with the AIP or the topic of interest changes to a different untreated topic. Interests of the user are discovered via user interaction with the first advertisement message and the subsequent advertisement messages.

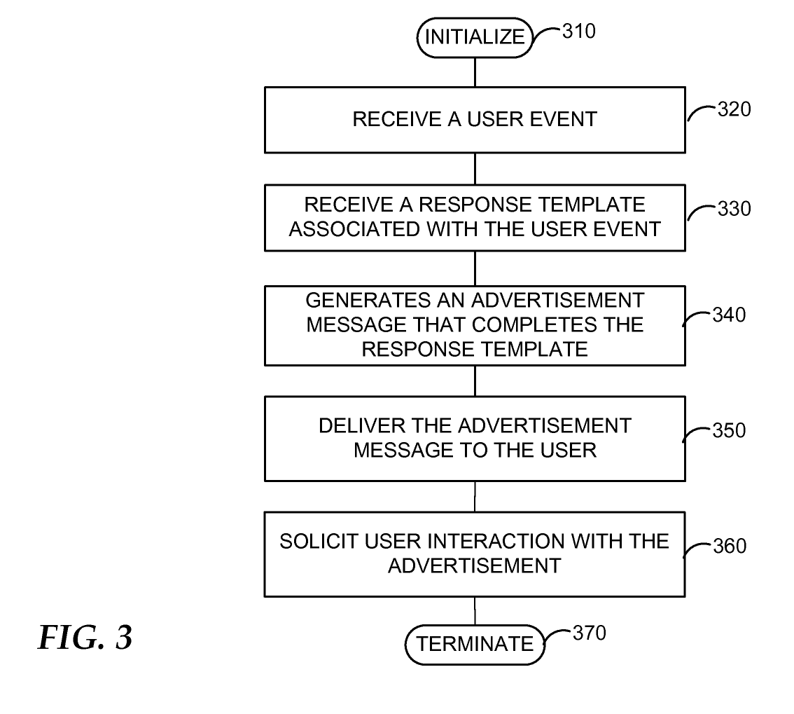

FIG. 3 is a logic diagram illustrating an exemplary method of providing interactive advertisement sessions in accordance with embodiments of the invention. The method initializes in step 310. In step 320, a user event is received in an advanced interactive platform. The user events include voice, gestures, emotional state, or keyboard strokes that are related to a topic that a user is presently interested in.

Additionally, a response template associated with the user event is received by the advertising engine, in step 330. In turn, an advertisement message that completes a response template is generated by the advertising engine using one or more advertising hints provided by advertisers, in step 340. In some embodiments, the advertising hints comprise brand, expertise, store location, special offers, and user targeting data. In step 350, the advertisement message is delivered to a user associated with the user event. In step 360, user interaction with the advertisement message is solicited to discover interests of the user. The user interaction with the advertisement message is incorporated in additional advertisement messages delivered to the user during an advertisement session. The advertisement messages are formatted as one of: an audio advertisement, a graphical advertisement, a video advertisement, or an animated graphical advertisement. In one embodiment, the additional advertisement messages are selected based on previous advertisement messages delivered to the user during an advertisement session. The additional advertisement messages are composed using advertising hints from different advertisers. The method ends in step 370.

For instance, a user may trigger a user event while interacting with the AIP if the user says, “hungry.” The AIP may have one or more response templates associated with the user event. For instance, the response template may include “You might want to try a {Food_Item} at {Food_Item_Location},” where {Food_Item} and {Food_Item_Location} are dynamic fields that can be populated using advertising hints. The AIP may transmit the response template to the advertising engine. The advertising engine obtains the appropriate advertising hints and populates the field to dynamically generate an advertisement “You might want to try an ACME burger at ACME Restaurant on 12^{th} St. NE.” In some embodiments, the advertising engine may narrow down advertisers based on targeting data specific to the user. For instance, the user may be on 10^{th} St. NE. Thus, the engine may narrow down the advertisers based on location. The targeting data may include location, emotional state, preferences, and interests of the user. The AIP formats the generated advertisement message and delivers it to the user. The AIP may format the generated advertisement as audio or as an animated digital avatar. The AIP may also include indications that user interaction with the generated advertisement is solicited. For instance, the generated advertisement may include, tell AIP more about what type of food you want, “a click here for more information, “or a click here for a special offer at this location.”

The user interaction with the generated advertisement triggers another user event. The user event may indicate that the advertisement message was not interesting to the user. Alternatively, the user event may indicate that it wants to know more about the food options. For instance, the user event may be a statement like: “What's the Price?” This user event will have a response template, e.g., “Only {Some_Dollars} Dollars,” in the AIP. The AIP forwards the response template to the advertisement engine, which populates the response template to dynamically generate the advertisement: “only 3 Dollars,” after processing relevant advertising hints. Additional user interaction may include another statement “I am not in the mood for a burger after a good work out, want something healthy!” Based on this user event, the AIP may select a response template specific to lower-calorie food options. The advertising engine receives the response templates and selects advertising hints from advertisers that offer low-calorie food options. Thus, in one advertisement session consisting of multiple user events, the advertising engine may switch between multiple advertisers.

In summary, an advanced interactive platform provided dynamically generated advertisement messages and continuously solicited user feedback to personalize the generated advertisement message to the current interests of the user. The advertisements are generated based on advertising hints. The user feedback is associated with various user events that correspond to response templates that are populated by the advertisement engine to generate appropriate advertisements during the advertisement session.

For instance, an advertiser may provide the following advertising hints: Brand is XY_Burger; Promotional Item: New Rocky Road Burger; Price: $6.99; Location: 100 Main St, Redmond, Wash. The AIP may include the following response templates: Template1: {Brand} {Promotional Item} {Price} {Location}; Template2: {Brand} {Promotional Item} {Location} {Price}; Template4: {Brand}; Template3: {Brand} {Promotional Item}; Template4: {Promotional Item} {Price}.

So, when the user interacting with the AIP indicates an interest in food, the advertising engine may utilize the advertising hints and response templates to dynamically generate any of the following advertisement messages: “Hey, XY_Burger just put out a New Rocky Road Burger—looks yummy”; “XY_Burger has a new promotion: New Rocky Road Burger. Want to learn more?”; “How about an XY_Burger if you are hungry.” Accordingly the advertisement messages are able to communicate a brand to the user.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. A computer-implemented method for providing interactive advertisement sessions, the method comprising:
receiving a first user event from an advanced interactive platform;
receiving a first response template associated with the first user event;
generating a first advertisement message by populating a response template with one or more advertising hints provided by advertisers;
delivering the first advertisement message to the advanced interactive platform;
soliciting user interaction with the first advertisement message delivered to the advanced interactive platform;
receiving subsequent user events based on the user interaction with the first advertisement message;
receiving subsequent response templates associated with the subsequent user events;
generating subsequent advertisement messages by populating the subsequent response templates with the one or more advertising hints; and
discovering interests of the user via user interaction with the first advertisement message and the subsequent advertisement messages.

2. The method of claim 1, wherein the first and subsequent user events include voice, gestures, emotional state, or keyboard strokes that are related to a topic that a user is presently interested in.

3. The method of claim 1, wherein the advertising hints comprise brand, expertise, store location, special offers, and user targeting data.

4. The method of claim 1, wherein the first and subsequent advertisement messages are formatted as one of: an audio advertisement, a graphical advertisement, a video advertisement, or an animated graphical advertisement.

5. The method of claim 1, wherein the subsequent response templates are selected based on the first response template.

6. The method of claim 5, wherein the subsequent response templates are populated with advertising hints from advertisers that differ from the advertising hints used to populate the first response template.

7. The method of claim 5, wherein subsequent response templates are populated with additional advertising hints from the same advertiser whose advertising hints were used to populate the first response template.

8. The method of claim 1, wherein an advertising session begins when the first user event is received by an advertising engine.

9. The method of claim 1, wherein the advertising session ends when the users cease to interact with the advanced interactive platform or the topic of interests changes to a different untreated topic.

10. A server computer executing an advertising engine configured to initiate advertising sessions, the server computer comprising:
a database configured to store advertising hints received from advertisers; and
an advertising engine configured to receive user events and response templates associated with the user events, wherein the advertising engine populates the response templates to generate advertisement messages that are transmitted to the user and the advertising engine solicits user interaction with the advertisement messages to discover the user's interests.

11. The server computer of claim 10, wherein the advertising engine updates the advertisement message based on subsequent user events and subsequent response templates.

12. The server computer of claim 10, wherein the advertising engine opens an advertising session with a user when the user event is received.

13. The server computer of claim 12, wherein the advertising engine closes the advertising session when the topic of interest changes.

14. The server computer of claim 10, wherein the advertising engine closes the advertising session when the user ceases to interact with the advertisement.

15. One or more computer readable media storing computer-useable instruction for performing a method that provides an interactive advertisement session, the method comprising:
receiving a user event from an advanced interactive platform;
receiving a response template associated with the user event;
generating an advertisement message that completes a response template using one or more advertising hints provided by advertisers; and
delivering the advertisement message to a user; and
soliciting user interaction with the advertisement message to discover interests of the user that are incorporated in additional advertisement messages delivered to the user.

16. The media of claim 15, wherein the user events include voice, gestures, emotional state, or keyboard strokes that are related to a topic that a user is presently interested in.

17. The media of claim 15, wherein the advertising hints comprise brand, expertise, store location, special offers, and user targeting data.

18. The media of claim 15, wherein the advertisement message is formatted as one of: an audio advertisement, a graphical advertisement, a video advertisement, or an animated graphical advertisement.

19. The media of claim 15, wherein the additional advertisement messages are selected based on previous advertisement messages delivered to the user.

20. The media of claim 19, wherein the additional advertisement messages are composed using advertising hints from different advertisers.
